(19) United States
(12) Patent Application Publication
(10) Pub. No.: US 2011/0092406 A1
(43) Pub. Date: Apr. 21, 2011

(54) PROCESS FOR MAKING A SECONDARY ALCOHOL CLEANING PRODUCT

(76) Inventors: Kirk Herbert Raney, Houston, TX (US); Paul Gregory Shpakoff, Houston, TX (US); Bryan Matthew White, Katy, TX (US)

(21) Appl. No.: 12/670,011

(22) PCT Filed: Jul. 22, 2008
(86) PCT No.: PCT/US08/70749

§ 371 Date: Dec. 14, 2010

Related U.S. Application Data
(60) Provisional application No. 60/951,481, filed on Jul. 24, 2007.

(51) Int. Cl. C11D 1/14

(52) U.S. Cl. 510/218; 510/337; 510/357; 510/493

(57) ABSTRACT

A process for making a useful cleaning product from an alkoxylate of a secondary alcohol which comprises: (a) partially sulfating a secondary alcohol alkoxylate with sulfur trioxide in a falling film sulfation reactor at a molar ratio of sulfur trioxide to secondary alcohol alkoxylate of less than 0.9 to produce a mixture comprising a sulfuric acid ester of the secondary alcohol alkoxylate and secondary alcohol alkoxylate which may comprise at least 50 percent by weight of the sulfuric acid ester of the secondary alcohol alkoxylate, (b) combining the mixture with a neutralizing agent in an amount sufficient to neutralize the sulfuric acid ester, and (c) optionally adding water to yield a useful cleaning product.

### FIELD OF THE INVENTION

This invention relates to a process for making surface active compositions which can be used to make useful cleaning products. More particularly, the invention relates to a falling film sulfation process for making a surface active composition from a secondary alcohol alkoxy sulfate which can be used to make a useful cleaning product.

### BACKGROUND OF THE INVENTION

Liquid surface active (surfactant) compositions are well known in the field of laundry detergents and other cleaning products. Alcohol ethoxy sulfates have been used advantageously in laundry detergents and other cleaning products as part of mixed active surfactant systems. EP 0 431 653 describes a process for making alcohol ethoxy sulfate/alcohol ethoxylate surface active compositions which contain low amounts of toxic 1,4-dioxane such that the compositions are useful in laundry detergents and other cleaning products.

Primary alcohols are the most commonly used alcohols for making this kind of surface active compositions. However, secondary alcohols have advantages over primary alcohols in some situations. For instance, secondary alcohol ethoxylates make superior non-ionic detergents relative to primary alcohol ethoxylates, especially in terms of lower washing temperatures. Secondary alcohol ethoxy sulfates offer comparable properties relative to primary alcohol ethoxy sulfates but there may be some instances in which secondary alcohol ethoxy sulfates offer a cost advantage.

When primary alcohol alkoxylates are sulfated using falling film sulfation technology, 98+ percent sulfation can be achieved without the formation of olefins. Olefins adversely effect the cleaning ability of surface active compositions because they function as an unwanted soil and a defoamer which decreases the surfactant performance in cleaning, foaming, and formulatability.

When secondary alcohols are sulfated using falling film sulfation technology, high levels of olefins are produced when the conversion to the sulfate is greater than 80 percent. The olefins have to be removed in order to use these secondary alcohol alkoxy sulfates to make useful cleaning products. More than 1 percent by weight of olefin in the surfactants leads to reduced surfactant performance as noted above.

Other more expensive sulfation technology (sulfuric or chlorosulfuric acid) can be used to solve this problem. However, this increases the cost of the product and it would be advantageous to produce a secondary alcohol alkoxy sulfate liquid surface active composition using falling film sulfation technology which does not produce more than 1 percent by weight olefin in the sulfation product.

### SUMMARY OF THE INVENTION

This invention provides a process for making a surface active composition from a secondary alcohol alkoxylate. The surface active composition is one which may be used to make a useful cleaning product because it contains only low levels of olefin. The process comprises:

(a) partially sulfating a secondary alcohol alkoxylate with sulfur trioxide in a falling film sulfation reactor at a molar ratio of sulfur trioxide to secondary alcohol alkoxylate of less than 0.9 to produce a mixture comprising a sulfuric acid ester of the secondary alcohol alkoxylate and secondary alcohol alkoxylate which may comprise at least about 50 up to about 85 percent by weight of the sulfuric acid ester of the secondary alcohol alkoxylate,

(b) combining the mixture with a neutralizing agent in an amount sufficient to neutralize the sulfuric acid ester, and

(c) optionally adding water to yield a useful cleaning product.

### DETAILED DESCRIPTION OF THE INVENTION

These materials may be made by starting with methane as the original feedstock. Synthesis gas (carbon monoxide and hydrogen) is generated from methane by using either partial oxidation or steam reforming. Linear paraffins in the plasticizer alcohol range, typically from 6 to 10 carbon atoms, are produced from the synthesis gas using Fischer Tropsch chemistry. The paraffins thus produced may first be hydrotreated to remove olefins and oxygenates. Aromatics may also be removed by extraction or extractive distillation as needed. The desired paraffins are then separated into appropriate carbon number fractions by, for example, distillation.

In general, the preparation of hydrocarbons (paraffins) from a mixture of carbon monoxide and hydrogen at elevated temperature and pressure in the presence of a suitable catalyst is known as the Fischer-Tropsch hydrocarbon synthesis. Catalysts in this synthesis usually comprise one or more metals from groups VIII, IX and X of the Periodic Table of Elements, optionally with one or more promoters, and a carrier material. In particular, iron, nickel, cobalt and rhuthenium are well known catalytically active metals for such catalysts and can be used in the present process. Processes and catalysts for this reaction are described in U.S. Pat. Nos. 7,105,706 and 6,740,683, both of which are incorporated herein by reference in their entirety.

After carbon monoxide and hydrogen have reacted to produce a hydrocarbon fraction, this hydrocarbon fraction may be separated into one or more hydrocarbon fractions of paraffins. The separation may involve a distillation treatment, such as fractional distillation. The catalyst and conditions may be selected such that the hydrocarbon fraction obtained is suitable to make secondary alcohols of C₁₀ to C₁₈ for use in the process of the present invention.

Secondary alcohols may be produced from the paraffins by either oxidizing the paraffins into secondary alcohols or by first brominating the paraffins to form the corresponding mono-alkyl bromide, followed by coupling with water in the presence of a metal oxide to produce the secondary alcohol. Examples of secondary alcohols which may be made herein include 2-undecanol, 2-hexanol, 3-hexanol, 2-heptanol, 3-heptanol, 2-octanol, 3-octanol, 2-nonanol, 2-decanol, 4-decanol, 2-dodecanol, 2-tetradecanol, 2-hexadecanol, and mixtures thereof.

The paraffins may be oxidized in the presence of a weak acid, preferably boric acid. Boric acids, including orthoboric acid, metaboric acid, and boric oxide, will readily form esters with secondary alcohols. This is important to prevent further oxidation of the secondary alcohols. Metaboric acid is preferred but may be formed from orthoboric acid by dehydration. Metaboric acid and paraffins are introduced into an oxidation reaction along with oxidizing gas which may be oxygen, air, or an inert gas such as nitrogen with a low concentration of oxygen. The rate of oxidation may be controlled by limiting the amount of oxygen absorbed. The oxidation reaction may be carried out at a temperature from about 150 to about 175° C.

The reaction of the secondary alcohols with the metaboric acid to form metaborate esters of the secondary alcohols is reversible. Water may be removed during the oxidation to drive the reaction to produce more esters. The oxidation reaction mixture is then distilled to remove unreacted paraffins. The next step is hydrolysis of the borate esters to form secondary alcohols and boric acid. Water is added to the borate ester and the secondary alcohols may be separated by decantation of the aqueous boric acid phase. Residual organic acids, boric acid and organic esters are removed by saponification of the secondary alcohol reaction mixture with a base. The mixture is allowed to settle and the base (aqueous) layer is removed.

The secondary alcohols may then be alkoxylated by reacting them with an alkylene oxide such as ethylene oxide or propylene oxide in the presence of an appropriate alkoxylation catalyst. The alkoxylation catalyst may be sodium hydroxide which is commonly used commercially for alkoxylating alcohols.

Secondary alcohol alkoxylates may be prepared by adding to the secondary alcohol or mixture of secondary alcohols a calculated amount, for example from about 0.1 percent by weight to about 0.6 percent by weight, of a strong base, typically an alkali metal or alkaline earth metal hydroxide such as sodium hydroxide or potassium hydroxide, which serves as a catalyst for alkoxylation. An amount of alkylene oxide calculated to provide the desired number of moles of alkylene oxide per mole of secondary alcohol is then introduced and the resulting mixture is allowed to react until the alkylene oxide is consumed. Suitable reaction temperature range from about 120 to about 220° C.

The secondary alcohols may be alkoxylated using a multi metal cyanide catalyst as described in U.S. Pat. No. 6,977,236 which is herein incorporated by reference in its entirety. The secondary alcohol alkoxylates of the present invention may be prepared by using a multi-metal cyanide catalyst as the alkoxylation catalyst. The catalyst may be contacted with the secondary alcohol and then both may be contacted with the alkylene oxide reactant which may be introduced in gaseous form. The reaction temperature may range from about 90° C. to about 250° C. and super atmospheric pressures may be used if it is desired to maintain the secondary alcohol substantially in the liquid state.

The secondary alcohols may also be alkoxylated using a lanthanum-based or a rare earth metal-based alkoxylation catalyst as described in U.S. Pat. Nos. 5,059,719 and 5,057,627, both of which are herein incorporated by reference in their entirety. Narrow range secondary alcohol alkoxylates may be produced utilizing a soluble basic compound of elements in the lanthanum series as the alkoxylation catalyst. Lanthanum phosphate is particularly useful. The alkoxylation is carried out employing conventional reaction conditions such as those described above.

Suitable alkylene oxide reactants for use herein include an alkylene oxide (epoxide) reactant which comprises one or more vicinal alkylene oxides, particularly the lower alkylene oxides and more particularly those in the C₂₋₄ range. In general, the alkylene oxides are represented by formula (I)

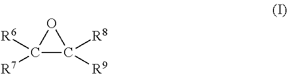

wherein each of the R⁶, R⁷, R⁸ and R⁹ moieties is individually selected from the group consisting of hydrogen and alkyl moieties. Reactants which comprise ethylene oxide, propylene oxide, butylene oxide, or mixtures thereof are more preferred, particularly those which consist essentially of ethylene oxide and propylene oxide. Alkylene oxide reactants consisting essentially of ethylene oxide are considered most preferred from the standpoint of commercial opportunities for the practice of alkoxylation processes, and also from the standpoint of the preparation of products having narrow-range ethylene oxide adduct distributions.

It should be understood that the alkoxylation procedure serves to introduce a desired average number of alkylene oxide units per mole of secondary alcohol alkoxylate. For example, treatment of a secondary alcohol mixture with 3 moles of alkylene oxide per mole of secondary alcohol serves to effect the alkoxylation of each alcohol molecule with an average of 3 alkylene oxide moieties per mole of secondary alcohol moiety, although a substantial proportion of secondary alcohol moieties will have become combined with more than 3 alkylene oxide moieties and an approximately equal proportion will have become combined with less than 3. In a typical alkoxylation product mixture, there is also a minor proportion of unreacted secondary alcohol. The amount of alkylene oxide added to the secondary alcohol may range from about 0.5 to about 12 moles of alkylene oxide per mole of secondary alcohol. It is preferred that at least about 1 mole be utilized in order to minimize the amount of unalkoxylated secondary alcohol in the reaction mixture.

The secondary alcohol alkoxylates may be sulfated using sulfur trioxide. The sulfation may be carried out at a temperature preferably not above about 80° C. The sulfation may be carried out at a temperature as low as about −20° C. but higher temperatures are more economical. For example, the sulfation may be carried out at a temperature of from about 20 to about 70° C., preferably from about 20 to about 60° C., and more preferably from about 20 to about 50° C.

The secondary alcohol alkoxylates may be reacted with a gas mixture which in addition to at least one inert gas contains from about 1 to about 8 percent by volume, relative to the gas mixture, of gaseous sulfur trioxide, preferably from about 1.5 to about 5 percent volume. In principle, it is possible to use gas mixtures having less than 1 percent by volume of sulfur trioxide but the space-time yield is then decreased unnecessarily. Inert gas mixtures having more than 8 percent by volume of sulfur trioxide in general may lead to difficulties due to uneven sulfation, lack of consistent temperature and increasing formation of undesired byproducts. Although other inert gases are also suitable, air or nitrogen are preferred, as a rule because of easy availability.

The reaction of the secondary alcohol alkoxylate with the sulfur trioxide containing inert gas may be carried out in falling film reactors. Such reactors utilize a liquid film trickling in a thin layer on a cooled wall which is brought into contact in a continuous current with the gas. Single- or multi-tube falling film reactors would be suitable as possible reactors.

The molar ratio of sulfur trioxide to alkoxylate may be less than about 0.9. If the ratio is higher, then an unacceptable level of olefin will be produced, i.e., greater than about 1 percent by weight. Generally, the ratio of sulfur trioxide to alkoxylate should not be less than about 0.5 because it is desirable to produce as much secondary alcohol alkoxy sulfate as possible to take advantage of its superior cleaning ability when used in surfactants and cleaning products.

Following sulfation, the liquid reaction mixture is neutralized using, for example, aqueous metal hydroxide, magnesium hydroxide, ammonium hydroxide, substituted ammonium hydroxide, sodium carbonate, calcium hydroxide, or sodium hydroxide. The neutralization procedure may be carried out over a wide range of temperatures and pressures. For example, the neutralization procedure may be carried out at a temperature from about 20 to about 65° C. and a pressure in the range from about 100 to about 200 kPa. The neutralization time may be in the range from about 0.5 hours to about 1 hour but shorter and longer times may be used where appropriate.

Following partial sulfation of the secondary alcohol alkoxylate, the sulfuric acid ester of the alcohol alkoxylate formed during partial sulfation exits from the falling film reactor and is combined with a neutralizing agent sufficient to neutralize the sulfuric acid ester and then optionally with an amount of water sufficient to yield a useful surface active composition.

In a preferred embodiment, the average number of oxyalkylene units per molecule in the alcohol alkoxylate which is partially sulfated may typically be in the range from about 0.5 to about 12, preferably from about 0.5 to about 5, and more preferably from about 1 to about 3.

It is preferred that the mixture of the sulfuric acid ester of the secondary alcohol alkoxylate and the unreacted secondary alcohol alkoxylate may comprise at least about 50 up to about 85 percent by weight of the secondary alcohol alkoxy sulfate in order to make a more useful product and take advantage of the superior cleaning ability of the secondary alcohol alkoxy sulfate. However, the secondary alcohol alkoxylates are also useful surfactants and it may be useful in some applications for them to be present in higher concentrations. Preferably the secondary alcohol alkoxy sulfate comprises at least about 70 percent of the mixture and more preferably at least about 80 percent of the mixture, for example, when the intended use is in liquid dishwashing formulations or personal care cleansers. A higher level of the ethoxylate is preferred for low foaming applications such as industrial cleaners and detergents for front-loading washers—for instance at least about 20 up to about 70 percent by weight of the mixture of sulfate and alkoxylate.

The preferred alkylene oxide for making the alkoxylates of the present invention is ethylene oxide. Thus, secondary alcohol ethoxylates are preferred as are secondary alcohol ethoxy sulfates. The surface active compositions prepared according to the process of the invention may be utilized in a variety of detergent applications and in a variety of other cleaning applications. The liquid surface active compositions may be blended at relatively low temperatures, about 60° C. or less, with solid detergent materials such as, for example, sodium carbonate, in order to form mixed active dry detergent powders. The liquid surface active composition may optionally be added to water to form liquid detergents having lower active matter concentrations. The liquid surface active composition may be used directly as a household hard-surface or liquid laundry cleaning product. The surface active compositions may be added to other materials to form other cleaning products such as heavy duty powder detergents or light duty dishwashing liquid detergents.

The amount of water utilized in the surface active composition may be less than about 15 percent by weight of the composition, preferably less than about 10 percent by weight, more preferably less than about 7 percent by weight, and most preferably, less than about 5 percent by weight. The amount of water may be controlled most efficiently when an anhydrous base, such as for example, triethanol amine or monoethanol amine, is used as the neutralizing agent in step (b) of the process. However, through drying or through addition of water, the amount of water can also be controlled in systems prepared with alkali metal neutralizing agents such as, for example, sodium and potassium hydroxide. The desired amount of water can readily be determined by one of ordinary skill in the art with a minimal amount of routine experimentation.

Suitable secondary alcohols for use in the process of this invention include secondary alcohols which contain from about 10 to about 18 carbon atoms, preferably from about 12 to about 17 carbon atoms because this is the range of carbon number which produces the best cleaning products. Blends of secondary alcohols may also be used. Specific secondary alcohols which are useful in the process of the present invention include those produced from refinery-grade paraffins or gas-to-liquids paraffins. Also, they can be produced from a variety of olefins.

This invention also provides a low viscosity surface active composition at low temperatures. Such a composition is useful for shipping and storage purposes because less heating and pumping energy are required to transport the material. In addition, the sulfate surfactant is unstable at temperatures greater than about 60° C. Therefore, low temperature storage and transport can minimize product degradation. The process described above makes a surface active product which is a mixture of a secondary alcohol alkoxylate and a sulfuric acid ester of the secondary alcohol alkoxylate. When this mixture comprises from about 54 to about 58 weight percent of the sulfuric acid ester, the viscosity of the surface active composition is very low, i.e., no more than 1000 cp at 40° C.

### EXAMPLES

### Example 1

A secondary alcohol ethoxylate (SAE) was sulfated at varying molar ratios of sulfur trioxide to ethoxylate. The sulfation was carried out by generating sulfur trioxide by passing sulfur dioxide in dry air over a heated catalyst bed containing vanadium pentoxide. Dry air was the carrier gas and source of oxygen. The hot stream of SO₃ in air was cooled by a heat exchanger, and then admitted to the thin film reactor (at about 1 g/min). The SAE was pumped to the film reactor and controlled at 0.1 ml/min. The SAE was spread to an even film along the reactor walls with nitrogen gas. As the feed was driven down the reactor column by the nitrogen gas, reaction occurred with SO₃. The product continued to flow downward until the sulfated product was collected at the bottom of the film reactor column in a caustic solution of sodium hydroxide mixed in a wareing blender. The temperature of the three zones of the reactor column (upper, middle, and lower) was controlled independently by temperature-controlled water bath circulators. Temperature was controlled to 25° C. The results are shown in Table 1 below.

TABLE 1

| | Feed LR# | | | |
|---|---|---|---|---|
| | 15477-25 | 15477-25 | 15477-25 | 15477-25 |
| | Product LR# | | | |
| | 26342-6 | 26342-7 | 26342-8 | 26342-9 |
| EO/ROH¹ | 1.6 | 1.5 | 1.7 | 1.7 |
| Avg R-Length (NMR) | 14.5 | 14.3 | 14.8 | 14.7 |
| Olefin Content (NMR) | 0.0% | 0.0% | 3.6% | 1.0% |
| Unreacted Ethoxylate | 37.2% | 17.5% | 20.8% | 24.8% |
| (NMR) | | | | |
| SO₃:SAE Molar Ratio | 0.77 | 0.89 | 0.98 | 0.89 |
| | Feed LR# | | | |
| | 15477-25 | 15477-25 | 15477-25 | 15477-25 |
| | Product LR# | | | |
| | 26342-10 | 26342-11 | 26342-12 | 26342-13 |
| EO/ROH Molar Ratio¹ | 1.7 | 1.7 | 1.6 | 1.6 |
| Avg R-Length (NMR) | 14.6 | 14.7 | 14.3 | 14.6 |
| Olefin Content (NMR) | 0.0% | 0.2% | 0.0% | 6.1% |
| Unreacted Ethoxylate | 26.9% | 34.9% | 42.0% | 16.5% |
| (NMR) | | | | |
| SO₃:SAE Molar Ratio | 0.84 | 0.77 | 0.70 | 1.04 |

| | Feed LR# | | |
|---|---|---|---|
| | 15477-25 | 15477-25 | 15477-25 |
| | Product LR# | | |
| | 26342-14 | 26342-15 | 26342-16 |
| EO/ROH¹ | 1.7 | 1.7 | 1.8 |
| Avg R-Length (NMR) | 14.6 | 14.8 | 15.3 |
| Olefin Content (NMR) | 11.5% | 18.0% | 20.4% |
| Unreacted Ethoxylate (NMR) | 17.3% | 6.0% | 9.5% |
| SO₃:SAE Molar Ratio | 1.03 | 1.08 | 1.11 |

¹molar ratio determined by C¹³ NMR

The samples were analyzed by NMR for average length of the molecule in terms of number of carbon atoms, for the olefin content and for the amount of unreacted ethoxylate. It can be seen that several of the samples produced very low amounts of olefin. The best sample was 26342-7 because no olefin was produced and the amount of unreacted ethoxylate was the lowest at 17.5%. Thus, the sample maximized the production of the secondary alcohol ethoxy sulfate.

Sample 26342-7 was analyzed by Raman IR Spectroscopy to insure that no olefin was present in the sample. Raman was chosen because it is not affected by the large amount of water present in the samples from neutralization and is more sensitive to the olefin C═C stretch than Fourier-Transform Infrared Spectroscopy (FTIR). No evidence of the presence of olefins was seen in the Raman spectrum of sample 26342-7.

### Example 2

Sample 26342-7 from Example 1 was compared in terms of detergency with a commercially available primary alcohol ethoxy sulfate. This material was NEODOL® 25-3S ethoxy sulfate which is made with a mixture of alcohols containing 12 and 15 carbon atoms which were ethoxylated to contain about 3 moles of EO per molecule and then sulfated.

Formulations were made using these two materials and commercially available NEODOL® 25-7 ethoxylate (an ethoxylate containing 7 moles of EO made from the above alcohol) and triethanol amine. Both formulations contained 15 percent by weight of the ethoxy sulfate, 15 percent by weight of the commercial alcohol ethoxylate, 3 percent by weight of triethanol amine and 67 percent by weight of water.

Duplicate terg-o-tometer test at 30° C. in 100 ppm hard water were conducted on swatches containing the following stains: protein and olive oil, dust sebum, and clay. The concentration of the detergent in the wash water was 4 grams per liter. The swatches were randomized such that replicate swatches were not present in the same group of four. Water (500 ml) was added to each stainless steel beaker followed by the addition of the test solutions. These solutions were agitated for 1 minute. One swatch was added per beaker. The swatches were collected after 10 minutes of agitation and transferred to a pitcher of water where they were rinsed for 30 seconds. Excess water was squeezed from the swatches and placed on a drying rack. The swatches were air dried and then scanned by a reflectometer.

The results indicated that there was no statistical difference in the detergency between detergents based on the secondary alcohol ethoxy sulfate made according to the present invention and the commercially available primary alcohol ethoxy sulfate.

### Example 3

A secondary alcohol having a range of carbon numbers from 14 to 17 was ethoxylated to produce an ethoxylate which had an average number of ethylene oxide units per molecule of about 1.5. Three different samples of this material were sulfated according to the procedure described in Example 1 at a molar ratio of sulfur trioxide to secondary alcohol ethoxylate of 0.8. The three products produced contained different levels of secondary alcohol ethoxylate sulfate as shown in Table 2 below. The viscosities of these samples were determined at 25° C., 40° C. and 50° C. (for one sample).

TABLE 2

| | Viscosity @ | Viscosity @ | Viscosity @ |
|---|---|---|---|
| SAES wt % | 25° C. | 40° C. | 50° C. |
| 27.3 | 35,737 | 41,498 | — |
| 56.0 | 544 | 243 | — |
| 64.2 | 22,876 | 6,909 | 34,598 |

It can be seen that the surface active composition which contained 56.0 weight percent of the secondary alcohol ethoxylate sulfate had a dramatically lower viscosity than the samples which had much lower and higher percentages of the SAS material.

1. A process for making a useful cleaning product from an alkoxylate of a secondary alcohol which comprises:
(a) partially sulfating a secondary alcohol alkoxylate with sulfur trioxide in a falling film sulfation reactor at a molar ratio of sulfur trioxide to secondary alcohol alkoxylate of less than 0.9 to produce a mixture comprising a sulfuric acid ester of the secondary alcohol alkoxylate and secondary alcohol alkoxylate which contains at least 50 percent by weight of the sulfuric acid ester of the secondary alcohol alkoxylate,
(b) combining the mixture with a neutralizing agent in an amount sufficient to neutralize the sulfuric acid ester, and
(c) optionally adding water to yield a useful cleaning product.

2. The product of the process of claim 1.

3. A powder or liquid detergent containing the product of claim 2.

4. A liquid dishwashing detergent containing the product of claim 2.

5. A cleaning product which comprises (a) from 85 to 100 percent by weight of a mixture of a secondary alcohol alkoxylate and a sulfuric acid ester of the secondary alcohol alkoxylate wherein the ester comprises from 50 to 85 percent by weight of the mixture, and (b) from 0 to 15 percent by weight of water.

6. The cleaning product of claim 5 wherein the ester comprises from 70 to 85 percent by weight of the mixture.

7. The cleaning product of claim 5 wherein the alkoxylate comprises from 20 to 70 percent by weight of the mixture.

8. The cleaning product of claim 5 wherein the alkoxylate is an ethoxylate.

9. The cleaning product of claim 5 wherein the secondary alcohol from which the alkoxylate was made contained from 10 to 18 carbon atoms.

10. The cleaning product of claim 5 wherein the alkoxylate contains from 0.5 to 5 moles of alkylene oxide.

11. A low viscosity surface active composition which comprises a mixture of a secondary alcohol alkoxylate and a sulfuric acid ester of the secondary alcohol alkoxylate wherein the ester comprises from 54 to 58 weight percent of the composition.

12. The composition of claim 11 where the alkoxylate is an ethoxylate.

13. The cleaning product of claim 11 wherein the alkoxylate contains from 0.5 to 5 moles of alkylene oxide.

14. The process of claim 1 wherein the molar ratio of sulfur trioxide to secondary alcohol alkoxylate is from 0.5 to less than 0.9.

15. A hard surface cleaner containing the product of claim 2.
